(19) United States
(12) Patent Application Publication
(10) Pub. No.: US 2005/0105887 A1
(43) Pub. Date: May 19, 2005

(54) Information recording apparatus and method, information reproducing apparatus and method, and information recording medium and recording medium

(76) Inventors: Nobuyuki Takakuwa, Tokorozawa-shi (JP); Takao Sawabe, Tokorozawa-shi (JP); Masanori Nakahara, Tokorozawa-shi (JP); Takeshi Koda, Tokorozawa-shi (JP); Tohru Kanegae, Tokorozawa-shi (JP); Yasuko Fukuda, Tokorozawa-shi (JP)

Correspondence Address: MORGAN LEWIS & BOCKIUS LLP, 1111 PENNSYLVANIA AVENUE NW, WASHINGTON, DC, 20004, US

(21) Appl. No.: 10/495,216

(22) PCT Filed: Nov. 12, 2002
(86) PCT No.: PCT/JP02/11798

(30) Foreign Application Priority Data
Nov. 13, 2001 (JP) 2001-347964

(51) Int. Cl. H04N 5/76

(52) U.S. Cl. 386/95; 386/108

(57) ABSTRACT

An information recording apparatus (S) is provided with: first format recording device (125) for recording an image information on a recording medium in first format; and second format recording device (125) for recording the image information on said recording medium in second format that is different from said first format.

### BACKGROUND OF THE INVENTION

1. Field of the Invention

The present invention relates to a technical field of an information recording apparatus and method, an information reproducing apparatus and method, a recording control program and a reproduction control program, and an information recording medium and a recording medium, and more particularly to an information recording apparatus and method for recording the image information on the recording medium to output the image information to the outside, a recording control program for making the recording process, an information reproducing apparatus and method for reproducing the recorded image information from the recording medium to be output to the outside, a reproduction control program for making the reproduction process, a recording medium where the image information is recorded, and an information recording medium where the recording control program and the reproduction control program are recorded.

2. Description of the Related Art

In recent years, the so-called DVD (Digital Versatile Disc) has widely spread as an optical disk having a storage capacity of several times that of the conventional CD (Compact Disc), and capable of recording the moving picture and the voice for one movie, in which this DVD is classified into a reproduction only DVD and a recordable DVD.

Specifically, the recordable DVDs include the DVD-R (DVD-Recordable), DVD-RW (DVD-Re-recordable) and DVD-RAM (DVD-Rewtitable), for which the standards have been set up.

According to the present standards regarding the recordable DVD, in addition to the moving picture such as the movie, the still image photographed by a digital still camera can be recorded on the DVD. Thus, the still image and the moving picture such as movie are recorded in accordance with the MPEG standards.

However, according to the conventional standards for the recordable DVD, the still image, like the moving picture, should be also recorded on the DVD in accordance with the MPEG standards. The MPEG standards for basically recording the moving picture in compression may be unsuitable for recording the still image in compression. As a result, the still image recorded on the DVD in accordance with the MPEG standards has its image quality inferior to that when recorded in accordance with the other standards dedicated for still image than the MPEG standards.

Therefore, there was an inconvenience that the still image could not be recorded on the DVD with an appropriate image quality to withstand the printing, when the still image recorded on the DVD in accordance with the MPEG standards for the output to a television apparatus was printed, for example.

### SUMMARY OF THE INVENTION

The present invention has been achieved in the light of the above inconveniences, and it is an object of the invention to provide an information recording apparatus and method, a recording control program for making the recording process, an information reproducing apparatus and method for reproducing the recorded image information from the DVD to be output to the outside, a reproduction control program for making the reproduction process, the DVD where the image information is recorded, and an information recording medium where the recording control program and the reproduction control program are recorded, in which the image information of same contents can be output by different methods, such as the display output to the television apparatus and the print output, and as a result, the universality in dealing with the image information is enhanced.

The above object of the present invention can be achieved by an information recording apparatus of the present invention. The information recording apparatus is provided with first recording device for recording an image information on a recording medium in first format; second format recording device for recording the image information on said recording medium in second format that is different from said first format; and a related information recording device for recording the related information for interrelating first format image information recorded in said first format, and the second format image information recorded in said second format onto said recording medium.

According to the present invention, because the image information is recorded in any of first format and second format, the image information of same contents can be output to the outside, employing any desired output method.

Furthermore, because the related information for associating first format image information and second format image information in correspondence relation is recorded on the recording medium, along with the first format image information and the second format image information, second format image information as required can be rapidly detected, in a case where while an image corresponding to the first format image information is output to the outside, the second format image information corresponding to the image being output is output to the outside, for example.

In one aspect of the present invention can be achieved by the information recording apparatus of the present invention. The related information relates a hierarchical structure of the first format image information and a hierarchical structure of the second format image information.

According to this aspect, because the hierarchical structures for first format and second format image information are associated in the related information, first format image information and the second format image information corresponding to the image of same contents can be readily retrieved.

In another aspect of the present invention can be achieved by the information recording apparatus of the present invention. The image information is still image information, the first format is a format for displaying the still image corresponding to the still image information on a television apparatus, and the second format is a format for printing the still image corresponding to the still image information.

According to this aspect, because first format image information is recorded in a display format for the television apparatus, and second format image information corresponding to the still image of same contents is recorded in a print format, the still image of same contents can be consistently displayed on the television apparatus and printed, employing one recording medium.

In further aspect of the present invention can be achieved by the information recording apparatus of the present invention. The first format is a still image format conforming to the MPEG (Moving Picture Experts Group) standards, and the second format is a still image format conforming to the JPEG (Joint Photographic Coding Experts Group) standards.

According to this aspect, because first format is a format for still image in accordance with the MPEG standards, and second format is a format for still image in accordance with the JPEG standards, the still image of same contents can be displayed on the television apparatus, and printed at high image quality at the same time.

The above object of the present invention can be achieved by an information reproducing apparatus of the present invention. The information reproducing apparatus for reproducing a recording medium which is provided with a first recording area for recording the image information in first format; a second recording area for recording the image information in second format that is different from said first format; and a related information recording area for recording the related information for interrelating first format image information recorded in said first format, and the second format image information recorded in said second format, is provided with a selection device for selecting one of the first format image information and the second format image information to be output to the outside; a detection device for detecting the other of the first format image information and the second format image information associated with the selected one of image information from the recording medium, on the basis of the recorded related information; and an output device for outputting the detected other image information to the outside with an output method corresponding to the second format.

According to the present invention, because second format image information corresponding to a selected first format image information or first format image information corresponding to a selected second format image information is detected on the basis of the related information and output to the outside, second format image information as required can be rapidly detected and output to the outside, in a case where while an image corresponding to first format image information is output to the outside, second format image information corresponding to the image being output is output to the outside, for example.

In one aspect of the present invention can be achieved by an information reproducing apparatus of the present invention. The information reproducing apparatus for reproducing a recording medium which is provided with a first recording area for recording the image information in first format; a second recording area for recording the image information in second format that is different from said first format; a related information recording area for recording the related information for interrelating first format image information recorded in said first format, and the second format image information recorded in said second format; and the image information is still image information, the first format is an output mode for displaying the still image corresponding to the still image information on a television apparatus, and the second format is an output mode for printing the still image corresponding to the still image information, is provided with a selection device for selecting any one of the still images corresponding to the first format image information displayed on the television apparatus; a detection device for detecting the still images corresponding to the second format image information associated with the selected still image from the recording medium, on the basis of the recorded related information; and an output device for outputting the detected still image to the outside for printing.

According to this aspect, because second format image information corresponding to a selected part of the still image displayed on the television apparatus is detected on the basis of the related information and output, the still image being displayed on the television apparatus can be printed separately.

The above object of the present invention can be achieved by an information recording method of the present invention. The information recording method is provided with a first recording process of recording the image information on a recording medium in first format; an second format recording process of recording the image information on said recording medium where said image information is recorded in said first format, using second format that is different from said first format; and a related information recording process of recording the related information for interrelating first format image information recorded in said first format, and the second format image information recorded in said second format onto said recording medium.

According to the present invention, because the image information is recorded in any of first format and second format, the image information of same contents can be output to the outside, employing any desired output method.

The above object of the present invention can be achieved by an information reproducing method of the present invention. The information reproducing method for reproducing a recording medium which is provided with a first recording area for recording the image information in first format; a second recording area for recording the image information in second format that is different from said first format; and a related information recording area for recording the related information for interrelating first format image information recorded in said first format, and the second format image information recorded in said second format, is provided with a selection process of selecting one of the first format image information and the second format image information to be output to the outside; a detection process of detecting the other of the first format image information and the second format image information associated with the selected one of image information from the recording medium, on the basis of the recorded related information; and an output process of outputting the detected other image information to the outside with an output method corresponding to the second format.

According to this aspect, because second format image information corresponding to a selected first format image information or first format image information corresponding to a selected second format image information is detected on the basis of the related information and output to the outside, second format image information as required can be rapidly detected and output to the outside, in a case where while an image corresponding to first format image information is output to the outside, second format image information corresponding to the image being output is output to the outside, for example.

In one aspect of the present invention can be achieved by the information reproducing method of the present invention. The information reproducing method for reproducing a recording medium which is provided with a first recording area for recording the image information in first format; a second recording area for recording the image information in second format that is different from said first format; a related information recording area for recording the related information for interrelating first format image information recorded in said first format, and the second format image information recorded in said second format; and the image information is still image information, the first format is an output mode for displaying the still image corresponding to the still image information on a television apparatus, and the second format is an output mode for printing the still image corresponding to said still image information, is provided with a selection process of selecting any one of the still images corresponding to the first format image information displayed on the television apparatus; a detection process of detecting the still images corresponding to the second format image information associated with the selected still image from the recording medium, on the basis of the recorded related information; and an output process of outputting the detected still image information to the outside for printing.

According to this aspect, because second format image information corresponding to a selected part of the still image displayed on the television apparatus is detected on the basis of the related information and output, the still image being displayed on the television apparatus can be printed separately.

The above object of the present invention can be achieved by a recording control program of the present invention. The recording control program that is executed on a recording computer built in an information recording apparatus for recording the image information on a recording medium, is provided with first format recording step for recording the image information on the recording medium in first format; second format recording step for recording the image information on said recording medium where said image information is recorded in said first format, using second format that is different from said first format; and related information recording step for recording the related information for interrelating first format image information recorded in said first format, and the second format image information recorded in said second format onto said recording medium.

According to the present invention, because the image information is recorded in any of first format and second format, the image information of same contents can be output to the outside, employing any desired output method.

The above object of the present invention can be achieved by a reproduction control program of the present invention. The reproduction control program that is executed on a reproducing computer built in an information reproducing apparatus for reproducing a recording medium which is provided with a first recording area for recording the image information in first format; a second recording area for recording the image information in second format that is different from said first format; and a related information recording area for recording the related information for interrelating first format image information recorded in said first format, and the second format image information recorded in said second format, is provided with a selection step for selecting one of the first format image information and the second format image information to be output to the outside; a detection step for detecting the other of the first format image information and the second format image information associated with the selected one of image information from the recording medium, on the basis of the recorded related information; and an output step for outputting the detected other image information to the outside with an output method corresponding to the second format.

According to the present invention, because second format image information corresponding to a selected first format image information or first format image information corresponding to a selected second format image information is detected on the basis of the related information and output to the outside under the control of the reproducing computer, second format image information as required can be rapidly detected and output to the outside, in a case where while an image corresponding to first format image information is output to the outside, second format image information corresponding to the image being output is output to the outside, for example.

In one aspect of the present invention can be achieved by a reproduction control program of the present invention. The reproduction control program that is executed on a reproducing computer built in an information reproducing apparatus for reproducing a recording medium which is provided with a first recording area for recording the image information in first format; a second recording area for recording the image information in second format that is different from said first format; a related information recording area for recording the related information for interrelating first format image information recorded in said first format, and the second format image information recorded in said second format; and the image information is still image information, the first format is an output mode for displaying the still image corresponding to said still image information on a television apparatus, and said second format is an output mode for printing the still image corresponding to said still image information, is provided with a selection step for selecting any one of the still images corresponding to the first format image information displayed on the television apparatus; a detection step for detecting the still images corresponding to the second format image information associated with the selected still image from the recording medium, on the basis of the recorded related information; and an output step for outputting the detected still image to the outside for printing.

According to this aspect, because second format image information corresponding to a selected part of the still image displayed on the television apparatus is detected on the basis of the related information and output under the control of the reproducing computer, the still image being displayed on the television apparatus can be printed separately.

The above object of the present invention can be achieved by an information recording medium of the present invention. The recording control program is recorded to be readable on the recording computer.

According to the present invention, when the recording control program is recorded, the image information is recorded in both first format and second format under the control of the recording computer that reads the recording control program and executes it, the image information of same contents can be output to the outside employing any desired output method.

Furthermore, the related information for associating first format image information and second format image information in correspondence relation is recorded on the recording medium, along with the first format image information and the second format image information under the control of the recording computer that reads the recording control program and executes it, second format image information as required can be rapidly detected, in a case where while an image corresponding to the first format image information is output to the outside, the second format image information corresponding to the image being output is output to the outside, for example.

Furthermore, under the control of the recording computer that reads the recording control program and executes it, because the hierarchical structures for first format and second format image information are associated in the related information, first format image information and the second format image information corresponding to the image of same contents can be readily retrieved.

Furthermore, under the control of the recording computer that reads the recording control program and executes it, because first format image information is recorded in a display format for the television apparatus, and second format image information corresponding to the still image of same contents is recorded in a print format, the still image of same contents can be consistently displayed on the television apparatus and printed, employing one recording medium.

Furthermore, under the control of the recording computer that reads the recording control program and executes it, because first format is a format for still image in accordance with the MPEG standards, and second format is a format for still image in accordance with the JPEG standards, the still image of same contents can be displayed on the television apparatus, and printed at high image quality at the same time.

In one aspect of the present invention can be achieved by an information recording medium of the present invention. The reproduction control program is recorded to be readable on the reproducing computer.

According to this aspect, when the reproduction control program is recorded, under the control of the reproducing computer that reads the reproduction control program and executes it, because second format image information corresponding to a selected first format image information or first format image information corresponding to a selected second format image information is detected on the basis of the related information and output to the outside under the control of the reproducing computer, second format image information as required can be rapidly detected and output to the outside, in a case where while an image corresponding to first format image information is output to the outside, second format image information corresponding to the image being output is output to the outside, for example.

Furthermore, when the reproduction control program as set forth in claim 21 is recorded, under the control of the reproducing computer that reads the reproduction control program and executes it, because second format image information corresponding to a selected part of the still image displayed on the television apparatus is detected on the basis of the related information and output under the control of the reproducing computer, the still image being displayed on the television apparatus can be printed separately.

In another aspect of the present invention can be achieved by an information recording medium of the present invention. The recording medium is provided with a first recording area for recording the image information in first format; a second recording area for recording the image information in second format that is different from said first format; and a related information recording area for recording the related information for interrelating first format image information recorded on said recording medium in said first format, and the second format image information recorded on said recording medium in said second format.

According to this aspect, because the image information is recorded in any of first format and second format, the image information of same contents can be output to the outside, employing any desired output method.

Furthermore, image information and second format image information in correspondence relation is recorded on the recording medium, along with the first format image information and the second format image information, second format image information as required can be rapidly detected, in a case where while an image corresponding to the first format image information is output to the outside, the second format image information corresponding to the image being output is output to the outside, for example.

In further aspect of the present invention can be achieved by an information recording medium of the present invention. The related information relates a hierarchical structure of the first format image information and a hierarchical structure of the second format image information.

According to this aspect, because the hierarchical structures for first format and second format image information are associated in the related information, first format image information and the second format image information corresponding to the image of same contents can be readily retrieved.

In further aspect of the present invention can be achieved by an information recording medium of the present invention. The image information is still image information, the first format is an output mode for displaying the still image corresponding to the still image information on a television apparatus, and the second format is an output mode for printing the still image corresponding to said still image information.

According to this aspect, because first format image information is recorded in a display format for the television apparatus, and second format image information corresponding to the still image of same contents is recorded in a print format, the still image of same contents can be consistently displayed on the television apparatus and printed, employing one recording medium.

In further aspect of the present invention can be achieved by an information recording medium of the present invention. The first format is a still image format conforming to the MPEG (Moving Picture Experts Group) standards, and the second format is a still image format conforming to the JPEG (Joint Photographic Coding Experts Group) standards.

According to this aspect, because first format is a format for still image in accordance with the MPEG standards, and second format is a format for still image in accordance with the JPEG standards, the still image of same contents can be displayed on the television apparatus, and printed at high image quality at the same time.

### BRIEF DESCRIPTION OF THE DRAWINGS

FIG. 1 is a diagram showing a physical format in a DVD according to an embodiment of the present invention;

FIG. 2 is a table for explaining contents of an identification code of the embodiment;

FIG. 3 is a table (I) showing a hierarchical structure of text information of the embodiment;

FIG. 4 is a table (II) showing a hierarchical structure of text information of the embodiment;

FIG. 5 is a block diagram showing a schematic configuration of an information recording apparatus according to the embodiment of the invention;

FIG. 6 is a flowchart showing a recording process of the embodiment; and

FIG. 7 is a flowchart showing an output process of the embodiment.

### DETAILED DESCRIPTION OF THE PREFERRED EMBODIMENTS

The preferred embodiments of the present invention will be described below with reference to the accompanying drawings.

An information recording/reproducing apparatus according to an embodiment of the invention records a still image on a DVD (recordable DVD) so that the recorded still image can be output on the television apparatus, and also output for the printing.

The DVD can record the moving picture displayed on the television apparatus, in addition to the still image.

(I) Embodiment of Recording Format

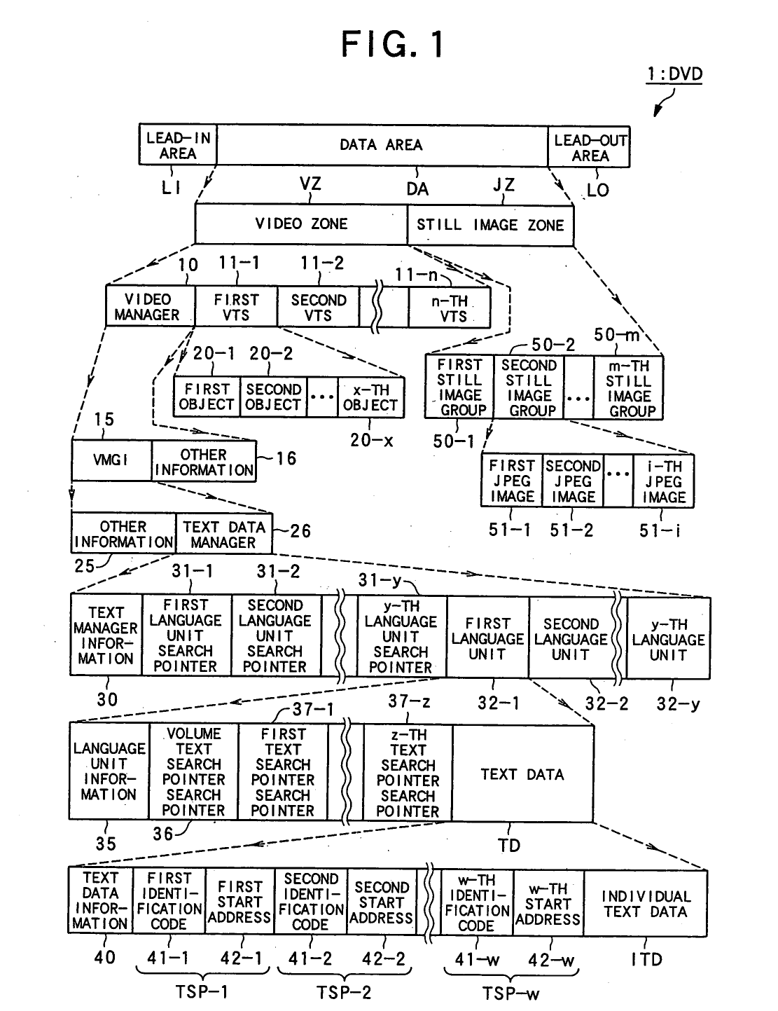

First of all, referring to FIGS. 1 to 4, a recording format for use in recording the still image on the DVD (hereinafter referred to as a recording format) in the information recording/reproducing apparatus will be schematically described below before the embodiment of the information recording/reproducing apparatus is concretely described.

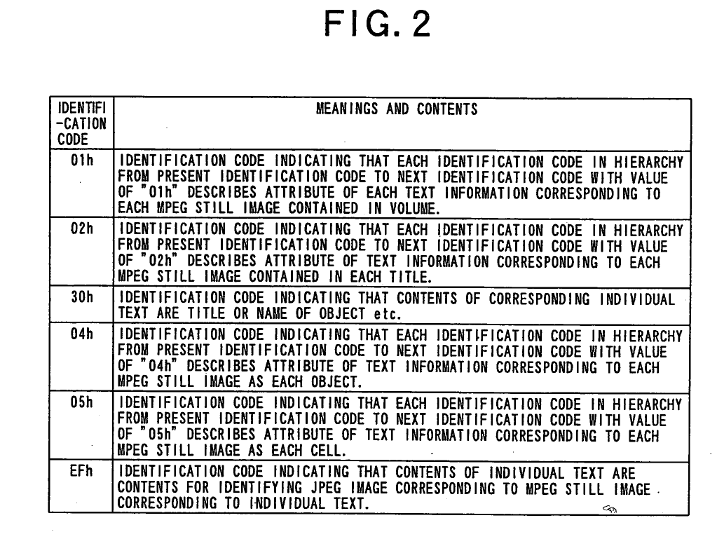

FIG. 1 is a diagram showing the recording format, and FIGS. 2 to 4 are tables exemplifying the configuration of text information in the recording format according to the embodiment.

As shown in FIG. 1, the DVD 1 where the still images (including both the still image and the moving picture) are recorded in the recording format of the embodiment is formed with a lead-in area LI in its innermost circumference, a lead-out area LO in its outermost circumference, and the data area DA where the still images are recorded between the lead-in area LI and the lead-out area LO.

The lead-in area LI has recorded the control information to be detected in starting the reproducing process of the still image recorded on the data area DA, while the lead-out area LO has recorded the control information to be detected in ending the reproducing process of the still image.

Next, the data area DA has a video zone VZ for recording the still image in accordance with the MPEG standards to be able to be displayed on the television apparatus, and a still image zone JZ for recording the still image in accordance with the so-called JPEG standards to be able to be printed by the printer.

The still image zone JZ is composed of a plurality of still image groups 50-1, 50-2, . . . , 50-m, each group containing a plurality of still images in accordance with the JPEG standards (the still image in accordance with the JPEG standards hereinafter referred to as the JPEG image), and each still image group 50 further containing a plurality of JPEG images 51-1, 51-2, . . . , 51-I.

In the video zone VZ, a video manager 10 at the top, and the still images in accordance with the MPEG standards (the still image in accordance with the MPEG standards hereinafter referred to as the MPEG image) that are divided into n VTS (Video Title Set) 11-1, 11-2, . . . , 11-n having ID (identification) number are recorded.

Herein, the VTS means a set (collection) of relevant (i.e., same number of still images and moving pictures, same specification or same attribute of corresponding language) titles (product that the producer of movie or the photographer of still image presents to the viewer), and more specifically for one same movie, the theater version and the special version are recorded with different titles.

One VTS 11 is composed of x objects 20-1, 20-2, . . . , and 20-x each corresponding to one still image in accordance with the MPEG standards. In the standards of recording format corresponding to the recordable DVD 1 that are defined in recent years, one object is partitioned into a plurality of information units called cells, in which one MPV still image corresponds to one cell, and one object 20 consists of one cell alone in the embodiment as described below (in other words, one object 20 contains only one MPEG still image).

In a hierarchical structure of text information as will be described later, it is assumed that one title is made up of a plurality of objects 20. Namely, in the hierarchical structure, it is assumed that one title is composed of a plurality of objects 20 (=one MPEG still image) having relevancy (specifically, the same photographing date).

Next, the video manager 10 is provided with a VMGI (Video Manager Information) 15 as general information involving. the still image recorded in the video zone VZ and the other information 16 that is the other information for video manager 10.

At this time, the VMGI 15 contains the overall information, including the image information and the audio information recorded on the DVD 1, such as the menu information indicating the name of each title, the illegal copy preventing information, and an access table for gaining access to each title.

In addition, the VMGI 15 contains the text (character) information according to the embodiment with the correspondence relation between the MPEG still image contained in the video zone VZ and the JPEG image 51 contained in the still image zone JZ as the object 20, namely, the text information indicating the name of one JPEG image 51 having the same contents of image as one MPEG still image. At this time, the text information has a hierarchical structure of the typical text information recorded in the video zone VZ, together with other MPEG still images. Also, the text information is recorded in a different language for the same contents. A collection of text information corresponding to one language is hereinafter referred to as a language unit.

Then, the VMGI 15 is provided with the other information 25 to be contained in the VMGI 15 such as the menu information, the illegal copy preventing information, and an access table, and a text data manager 26 involving the text information main body according to this embodiment.

The text data manager 26 is composed of the text manager information 30, a plurality of (y in FIG. 1) language unit search pointers 31-1 to 31-y, and a plurality of language units 32-1 to 32-y that are equal in the number to the language unit search pointers 31.

At this time, the text manager information 30 contains the identification information for identifying the text information from other information, and the information indicating the number of subsequent language units.

Each language unit search pointer 31 has the address information indicating the recording location on the DVD 1 recording the language unit 32 having a language code and a corresponding number indicating the language attribute (i.e., indicating the sort of language) for the text information contained in the language unit 32 having the corresponding number. The address information contained in the language unit search pointer 31 is written from the initial location of the text data manager 26 as the starting point.

Then, each language unit 32 is composed of the language unit information 35, a volume text search pointer search pointer 36, a plurality of (z in FIG. 1) text search pointer search pointer 37-1 to 37-z, and the text data TD.

At this time, the language unit information 35 contains the address information indicating the last recording position on the DVD 1 for the language unit 32 to which it belongs. The address information indicating the last recording position is written from the initial location of corresponding language unit 32 as the starting point.

The volume text search pointer search pointer 36 contains the address information indicating the recording position on the DVD 1 where the address information indicating the recording position on the DVD 1 for the volume as text information units collecting plural pieces of text information corresponding to each title is written. The address information as the volume text search pointer search pointer 36 is written from the initial location of corresponding language unit 32 as the starting point.

Further, each text search pointer search pointer 37 contains the address information (i.e., address information indicating the recording position of each text search pointer TSP on the DVD 1) indicating the recording position on the DVD 1 where the address information indicating the recording position on the DVD 1 for the text information corresponding to each title is written. The address information as the text search pointer search pointer 36 is written from the initial location of corresponding language unit 32 as the starting point.

The text data TD contains the text information main body in the embodiment as will be described later.

That is, the text data TD is composed of the text data information 40, a plurality of (w in FIG. 1) text search pointers TSP-1 to TSP-w, and individual text data ITD.

At this time, the text data information 40 contains the information indicating the number of subsequent text data search pointers TSP.

Each text search pointer TSP contains the identification codes 41-1 to 41-w for identifying the attribute of corresponding text information (i.e., text information corresponding to each MPEG still image) in individual text data ITD and the start addresses 42-1 to 42-w that are the address information indicating the recording position on the DVD 1 where the text information corresponding to each title is recorded. The address information as each start address 42 is written from the initial location of text data TD containing it as the starting point.

Finally, the individual text data TD contains various kinds of text information indicating the MPEG still image contained in each title with the attribute indicated by each identification code 41. The text information contained in the individual text data TD is recorded in a hierarchical structure as described below for the benefit of retrieval.

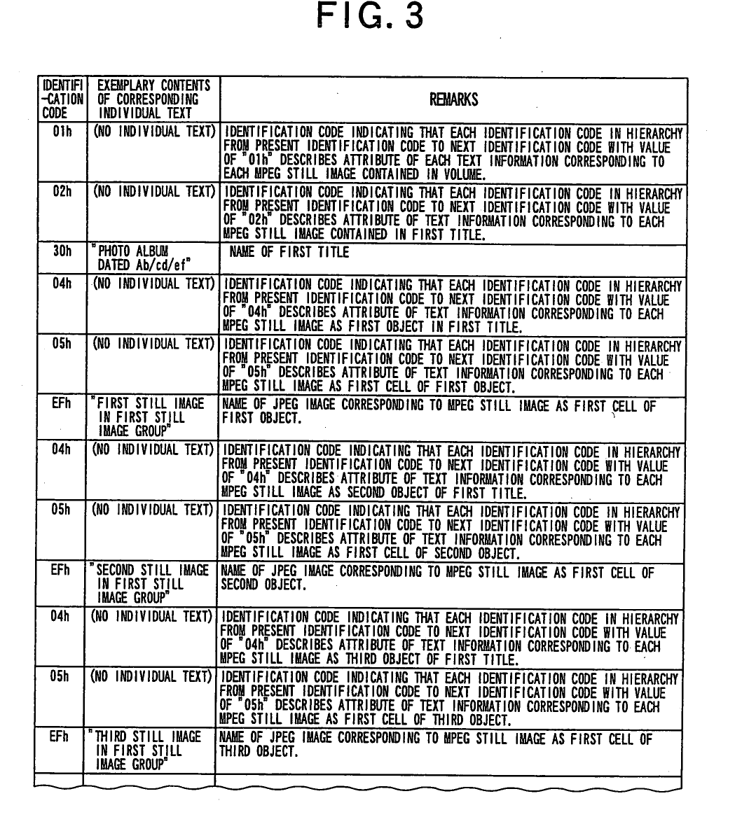

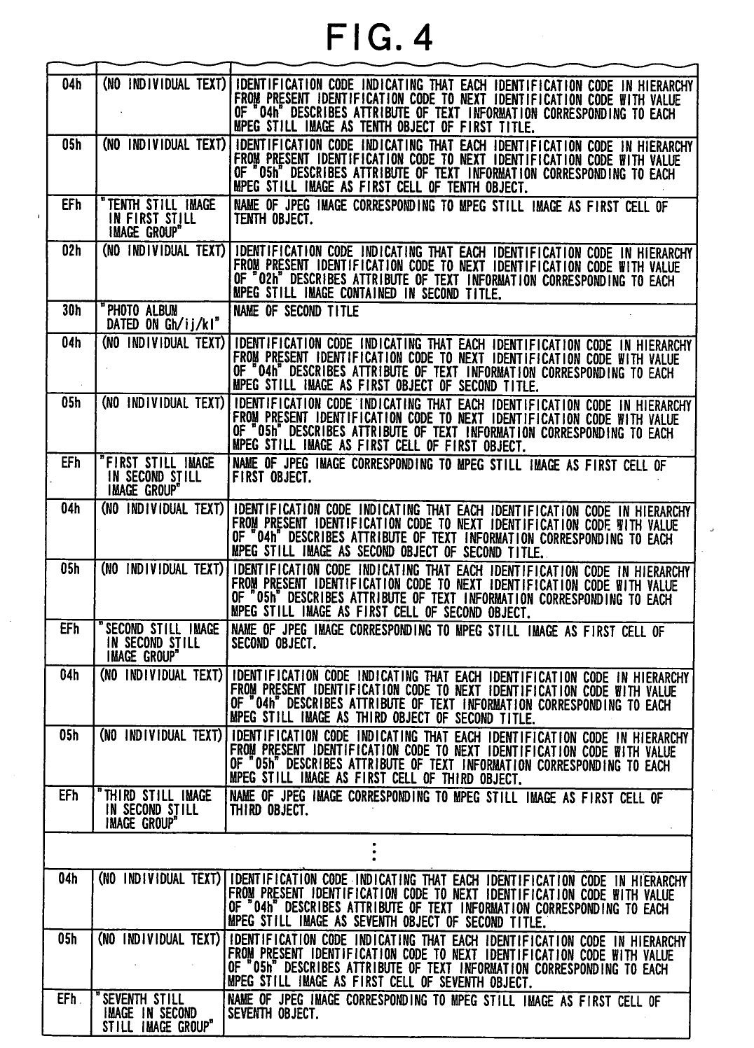

Then, referring to FIGS. 2 to 4, the hierarchical structure for the text information contained in the text data TD will be described below. FIG. 2 is a table for explaining the contents of meaning for each identification code 41. FIGS. 3 and 4 are tables exemplifying the hierarchical structure of text information indicated by the identification code 41.

FIGS. 2 to 4 show the hierarchical structure of text information representing the relation between the MPEG still image and the corresponding JPEG image 51 (i.e., with the same contents as the image) in an example in which the MPEG still images corresponding to ten JPEG images 51 photographed on the same day composing one object 20 (i.e., one cell) and a first title are recorded on the DVD 1, and the MPEG still images corresponding to seven JPEG images 51 photographed on the other day composing one object 20 and a second title are recorded on the DVD 1. At this time, it is supposed that ten JPEG images 51 corresponding to ten MPEG still images composing the first title composing a first still image group 50-1 are recorded on the DVD 1, and seven JPEG images 51 corresponding to seven MPEG still images composing the second title composing a second still image group 50-2 are recorded on the DVD 1. Then, the first still image group 50-1 corresponds to the first title containing ten MPEG still images, and the second still image group 50-2 corresponds to the second title containing seven MPEG still images.

As shown in FIGS. 2 to 4, the text information of this embodiment, an individual text having the attribute indicated by each identification code 41 is recorded at a recording position within an area of the DVD 1 where the individual text data ITD is recorded and designated at a start address 42 contained with the identification code 41 in the text search pointer TSP where the identification code 41 is contained.

Herein, some identification codes 41 have no individual text corresponding thereto and indicate only the hierarchical structure over the entire text information, and others have a specific individual text and indicate the specific attribute of individual text. For the identification code 41 having no corresponding individual text, the start address 42 in the search pointer TSP containing it is all “0”.

That is, the kinds of identification code 41 will be firstly explained below. In an example of FIGS. 3 and 4, there are the identification code 41 with a value of “01h”, the identification code 41 with a value of “02h”, the identification code 41 with a value of “04h”, the identification code 41 with a value of “05h”, the identification code 41 with a value of “30h”, and the identification code 41 with a value of “EFh”, as shown in FIG. 2.

The identification code 41 with the value of “01h” indicates that each identification code 41 in the hierarchy from the present identification code 41 with the value of “01h” to the next identification code 41 with the value of “01h” describes the attribute of each text information corresponding to each MPEG still image contained in the volume, and has no corresponding individual text.

Then, the identification code 41 with the value of “02h” indicates that each identification code 41 in the hierarchy from the present identification code 41 with the value of “02h” to the next identification code 41 with the value of “02h” describes the attribute of text information corresponding to each MPEG still image contained in each title, and has no corresponding individual text.

Also, the identification code 41 with the value of “04h” indicates that each identification code 41 in the hierarchy from the present identification code 41 with the value of “04h” to the next identification code 41 with the value of “04h” describes the attribute of text information corresponding to each MPEG still image as each object 20, and has no corresponding individual text.

Moreover, the identification code 41 with the value of “05h” indicates that each identification code 41 in the hierarchy from the present identification code 41 with the value of “05h” to the next identification code 41 with the value of “05h” describes the attribute of text information corresponding to each MPEG still image as each cell, and has no corresponding individual text.

Then, the identification code 41 with the value of “30h” has corresponding individual text, in which the content of the individual text is the title or the name of object.

Lastly, the identification code 41 with the value of “EFh” is one having the corresponding individual text, in which the contents of the individual text are the contents for identifying the JPEG image 51 corresponding to the MPEG still image for the identification code 41.

A specific hierarchical structure of the embodiment will be described below.

To begin with, the identification code 41 with the value of “01h” (corresponding to the first identification code 41-1 in FIG. 1) is disposed at the top of the hierarchical structure, as shown in FIG. 3. At this time, the identification code 41 with the value of “01h” indicates that each identification code 41 in the hierarchy from the present identification code 41 to the next identification code 41 with the value of “01h” describes the attribute of each text information corresponding to each MPEG still image contained in the volume of the embodiment.

Subsequently, the identification code 41 with the value of “02h” (corresponding to the second identification code 41-2 in FIG. 1) is disposed immediately below the identification code 41 with the value of “01h”. At this time, the identification code 41 with the value of “02h” indicates that each identification code 41 in the hierarchy from the present identification code 41 to the next identification code 41 with the value of “02h” describes the attribute of text information corresponding to each of ten MPEG still images contained in the first title.

Further, the identification code 41 with the value of “30h” is disposed immediately below the identification code 41 with the value of “02h”. At this time, the identification code 41 with the value of “30h” indicates that the text information indicating the name of first title (e.g., the name indicating the collection of MPEG still images recorded as the first title such as “a photo album dated on Ab/cd/ef” as shown in FIG. 3) is recorded at a recording position (within the individual text data ITD) on the DVD 1 as pointed to by the start address 42 contained in the text search pointer TSP containing the identification code 41.

Subsequently, the identification code 41 with the value of “04h” is disposed immediately below the identification code 41 with the value of “30h”. At this time, the identification code 41 with the value of “04h” indicates that each identification code 41 in the hierarchy from the present identification code 41 to the next identification code 41 with the value of “04h” describes the attribute of text information corresponding to each MPEG still image as the first object in the first title.

Further, the identification code 41 with the value of “05h” is disposed immediately below the identification code 41 with the value of “04h”. At this time, the identification code 41 with the value of “05h” indicates that each identification code 41 in the hierarchy from the present identification code 41 to the next identification code 41 with the value of “05h” describes the attribute of text information corresponding to each MPEG still image as the first object (=the first cell).

And, the identification code 41 with the value of “EFh” is disposed immediately below the identification code 41 with the value of “05h”. At this time, the identification code 41 with the value of “EFh” indicates that the text information indicating the name of JPEG image 51 corresponding to (having the same image contents as) the MPEG still image as the first object for the identification code 41 with the value of “05h” directly above (e.g., the name of JPEG image 51 corresponding to one MPEG still image recorded as the first object of the first title such as “the first still image in the first still image group” as shown in FIG. 3) is recorded at a recording position on the DVD 1 as pointed to by the start address 42 contained in the text search pointer TSP containing the identification code 41.

Subsequently, the identification code 41 with the value of “04h” is disposed immediately below the identification code 41 with the value of “EFh”. At this time, the identification code 41 with the value of “04h” indicates that each identification code 41 in the hierarchy from the present identification code 41 to the next identification code 41 with the value of “04h” describes the attribute of text information corresponding to each MPEG still image as the second object of the first title.

Further, the identification code 41 with the value of “05h” is disposed immediately below the identification code 41 with the value of “04h”. At this time, the identification code 41 with the value of “05h” indicates that each identification code 41 in the hierarchy from the present identification code 41 to the next identification code 41 with the value of “05h” describes the attribute of text information corresponding to each MPEG still image as the second object (=the first cell).

And, the identification code 41 with the value of “EFh” is disposed immediately below the identification code 41 with the value of “05h”. At this time, the identification code 41 with the value of “EFh” indicates that the text information indicating the name of JPEG image 51 corresponding to the MPEG still image as the second object for the identification code 41 with the value of “05h” directly above (e.g., the name of JPEG image 51 corresponding to one MPEG still image recorded as the second object of the first title such as “the second still image in the first still image group” as shown in FIG. 3) is recorded at a recording position on the DVD 1 as pointed to by the start address 42 contained in the text search pointer TSP containing the identification code 41.

Further, the identification code 41 with the value of “04h” is disposed again immediately below the identification code 41 with the value of “EFh”. At this time, the identification code 41 with the value of “04h” indicates that each identification code 41 in the hierarchy from the present identification code 41 to the next identification code 41 with the value of “04h” describes the attribute of text information corresponding to each MPEG still image as the third object of the first title.

Further, the identification code 41 with the value of “05h” is disposed immediately below the identification code 41 with the value of “04h”. At this time, the identification code 41 with the value of “05h” indicates that each identification code 41 in the hierarchy from the present identification code 41 to the next identification code 41 with the value of “05h” describes the attribute of text information corresponding to each MPEG still image as the third object (=the first cell).

And, the identification code 41 with the value of “EFh” is disposed immediately below the identification code 41 with the value of “05h”. At this time, the identification code 41 with the value of “EFh” indicates that the text information indicating the name of JPEG image 51 corresponding to the MPEG still image as the third object for the identification code 41 with the value of “05h” directly above (e.g., the name of JPEG image 51 corresponding to one MPEG still image recorded as the second object of the first title such as “the third still image in the first still image group” as shown in FIG. 3) is recorded at a recording position on the DVD 1 as pointed to by the start address 42 contained in the text search pointer TSP containing the identification code 41.

The names of JPEG image 51 corresponding to the MPEG still images recorded as the fourth object to the ninth object are written in hierarchy in the same way as the first object to the third object as described above.

The identification code 41 with the value of “04h” is disposed again as corresponding to the tenth object within the first title (i.e., the tenth MPEG still image within the first title) immediately below the hierarchy having the names of JPEG image 51 corresponding up to the ninth object are written. At this time, the identification code 41 with the value of “04h” indicates that each identification code 41 in the hierarchy from the present identification code 41 to the next identification code 41 with the value of “04h” describes the attribute of text information corresponding to each MPEG still image as the tenth object of the first title.

Further, the identification code 41 with the value of “05h” is disposed immediately below the identification code 41 with the value of “04h”. At this time, the identification code 41 with the value of “05h” indicates that each identification code 41 in the hierarchy from the present identification code 41 to the next identification code 41 with the value of “05h” describes the attribute of text information corresponding to each MPEG still image as the tenth object (=the first cell).

If writing the text information corresponding to ten MPEG still images recorded as the first title has been completed by writing a series of text information as described above, the identification code 41 with the value of “02h” is disposed as the identification code 41 indicating the second title recorded within the video zone VZ, following the first title. At this time, the identification code 41 with the value of “02h” indicates that each identification code 41 in the hierarchy from the present identification code 41 describes the attribute of text information corresponding to each MPEG still image contained in the second title.

Moreover, the identification code 41 with the value of “30h” is disposed immediately below the identification code 41 with the value of “02h”. At this time, the identification code 41 with the value of “30h” indicates that the text information indicating the name of second title (e.g., the name of the collection of MPEG still images recorded as the second title such as “photo album dated on Gh/ij/kl” as shown in FIG. 4) is recorded at a recording position on the DVD 1 as pointed to by the start address 42 contained in the text search pointer TSP containing the identification code 41.

Further, the identification code 41 with the value of “04h” is disposed again immediately below the identification code 41 with the value of “30h”. At this time, the identification code 41 with the value of “04h” indicates that each identification code 41 in the hierarchy from the present identification code 41 to the next identification code 41 with the value of “04h” describes the attribute of text information corresponding to each MPEG still image as the first object of the second title.

Further, the identification code 41 with the value of “05h” is disposed immediately below the identification code 41 with the value of “04h”. At this time, the identification code 41 with the value of “05h” indicates that each identification code 41 in the hierarchy from the present identification code 41 to the next identification code 41 with the value of “05h” describes the attribute of text information corresponding to each MPEG still image as the first object.

And, the identification code 41 with the value of “EFh” is disposed immediately below the identification code 41 with the value of “05h”. At this time, the identification code 41 with the value of “EFh” indicates that the text information indicating the name of JPEG image 51 corresponding to the MPEG still image as the first object for the identification code 41 with the value of “05h” directly above (e.g., the name of JPEG image 51 corresponding to one MPEG still image recorded as the first object of the second title such as “the first still image in the second still image group” as shown in FIG. 3) is recorded at a recording position on the DVD 1 as pointed to by the start address 42 contained in the text search pointer TSP containing the identification code 41.

Subsequently, the identification code 41 with the value of “04h” is disposed again immediately below the identification code 41 with the value of “EFh”. At this time, the identification code 41 with the value of “04h” indicates that each identification code 41 in the hierarchy from the present identification code 41 to the next identification code 41 with the value of “04h” describes the attribute of text information corresponding to each MPEG still image as the second object of the second title.

Further, the identification code 41 with the value of “05h” is disposed immediately below the identification code 41 with the value of “04h”. At this time, the identification code 41 with the value of “05h” indicates that each identification code 41 in the hierarchy from the present identification code 41 to the next identification code 41 with the value of “05h” describes the attribute of text information corresponding to each MPEG still image as the second object.

And, the identification code 41 with the value of “EFh” is disposed immediately below the identification code 41 with the value of “05h”. At this time, the identification code 41 with the value of “EFh” indicates that the text information indicating the name of JPEG image 51 corresponding to the MPEG still image as the second object for the identification code 41 with the value of “05h” directly above (e.g., the name of JPEG image 51 corresponding to one MPEG still image recorded as the second object of the second title such as “the second still image in the second still image group” as shown in FIG. 3) is recorded at a recording position on the DVD 1 as pointed to by the start address 42 contained in the text search pointer TSP containing the identification code 41.

Further, the identification code 41 with the value of “04h” is disposed again immediately below the identification code 41 with the value of “EFh”. At this time, the identification code 41 with the value of “04h” indicates that each identification code 41 in the hierarchy from the present identification code 41 to the next identification code 41 with the value of “04h” describes the attribute of text information corresponding to each MPEG still image as the third object of the second title.

Further, the identification code 41 with the value of “05h” is disposed immediately below the identification code 41 with the value of “04h”. At this time, the identification code 41 with the value of “05h” indicates that each identification code 41 in the hierarchy from the present identification code 41 to the next identification code 41 with the value of “05h” describes the attribute of text information corresponding to each MPEG still image as the third object.

And, the identification code 41 with the value of “EFh” is disposed immediately below the identification code 41 with the value of “05h”. At this time, the identification code 41 with the value of “EFh” indicates that the text information indicating the name of JPEG image 51 corresponding to the MPEG still image as the third object for the identification code 41 with the value of “05h” directly above (e.g., the name of JPEG image 51 corresponding to one MPEG still image recorded as the second object of the first title such as “the third still image in the second still image group” as shown in FIG. 3) is recorded at a recording position on the DVD 1 as pointed to by the start address 42 contained in the text search pointer TSP containing the identification code 41.

The names of JPEG image 51 corresponding to three MPEG still images recorded successively as the fourth object to the sixth object are written in the same way as the first object to the third object as described above.

The identification code 41 with the value of “04h” is disposed again as corresponding to the seventh object within the second title (i.e., the seventh MPEG still image within the second title) immediately below the hierarchy having the names of JPEG image 51 corresponding up to the sixth object are written. At this time, the identification code 41 with the value of “04h” indicates that each identification code 41 in the hierarchy from the present identification code 41 describes the attribute of text information corresponding to each MPEG still image as the seventh object of the second title.

Further, the identification code 41 with the value of “05h” is disposed immediately below the identification code 41 with the value of “04h”. At this time, the identification code 41 with the value of “05h” indicates that each identification code 41 in the hierarchy from the present identification code 41 describes the attribute of text information corresponding to each MPEG still image as the seventh object.

And, the identification code 41 with the value of “EFh” is disposed immediately below the identification code 41 with the value of “05h”. At this time, the identification code 41 with the value of “EFh” indicates that the text information indicating the name of JPEG image 51 corresponding to the MPEG still image as the seventh object for the identification code 41 with the value of “05h” directly above (e.g., the name of JPEG image 51 corresponding to one MPEG still image recorded as the seventh object of the second title such as “the seventh still image in the second still image group” as shown in FIG. 4) is recorded at a recording position on the DVD 1 as pointed to by the start address 42 contained in the text search pointer TSP containing the identification code 41.

(II) Embodiment of Information Recording/Reproducing Apparatus

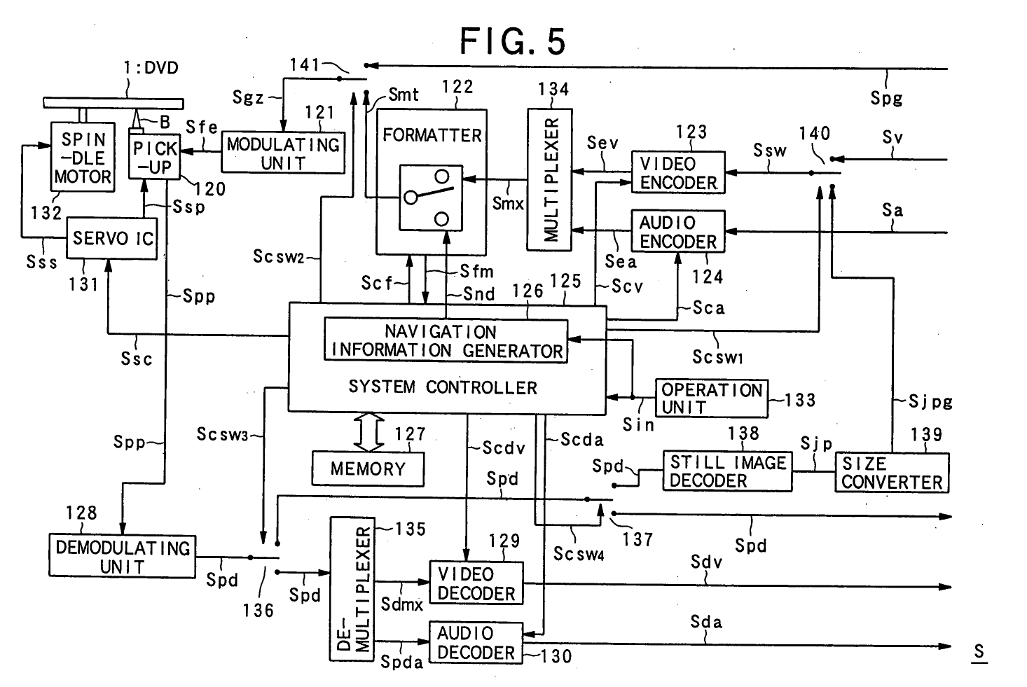

Referring to FIGS. 5 to 7, an embodiment of the information recording/reproducing apparatus that can record the MPEG still image and the corresponding JPEG image 51 on the DVD 1 in accordance with the recording format as described above, and reproducing them, as needed, will be described below.

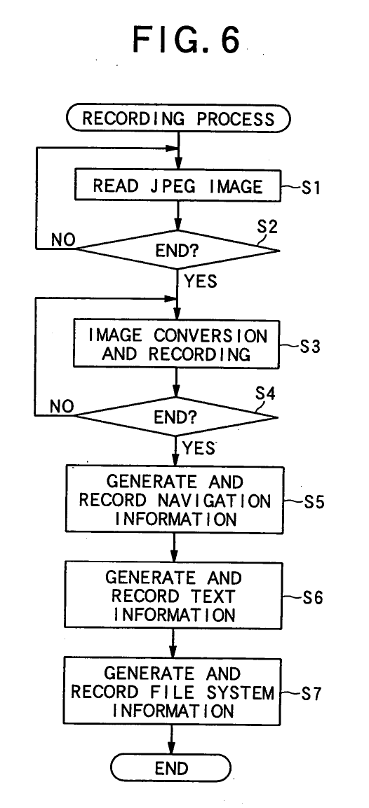

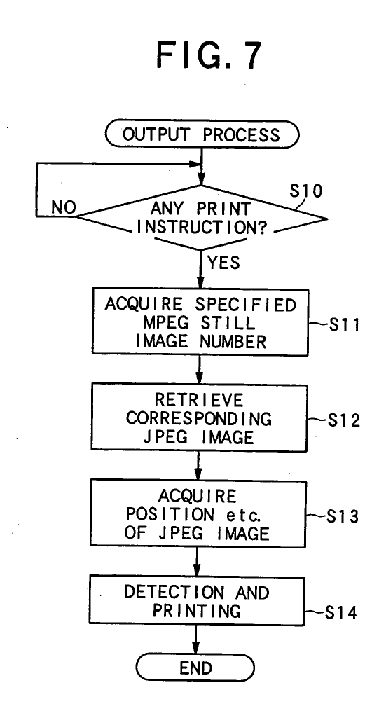

FIG. 5 is a block diagram showing the schematic configuration of the information recording/reproducing apparatus according to this embodiment. FIG. 6 is a flowchart showing a recording process that is performed in the information recording/reproducing apparatus. FIG. 7 is a flowchart showing an output process of the JPEG image 51 that is performed in the information recording/reproducing apparatus.

Referring to FIG. 5, the schematic configuration and the schematic operation of the information recording/reproducing apparatus according to the embodiment will be firstly described below.

As shown in FIG. 5, the information recording/reproducing apparatus S according to the embodiment is provided with a pickup 120 as detecting device, a modulating unit 121, a formatter 122, a video encoder 123, an audio encoder 124, a system controller 125 as first format recording device, second format recording device, related information recording device and output device, a memory 127, a demodulating unit 128, a video decoder 129, an audio decoder 130, a servo IC (Integrated Circuit) 131, a spindle motor 132, an operation unit 133 as selecting device, a multiplexer 134, a demultiplexer 135, the switches 136, 137, 140 and 141, a still image decoder 138, and a size converter 139.

The system controller 125 is provided with a navigation information generator 126 for generating the navigation information containing the text information as described above. Herein, the navigation information means a way of how to reproduce the information recorded on the DVD 1, or the reproduction control information recorded on the DVD 1 together with the recorded information to control the selection of the recorded information to be reproduced or the reproduction order of the selected recorded information, including the text information.

The schematic operation of each section will be described below.

(A) Embodiment of Recording/Reproducing Process for Moving Picture Information

To begin with, a recording process for recording the moving picture information (including the audio information) containing the moving picture except for the still image on the DVD 1 in accordance with the MPEG standards and a reproducing process for detecting and reproducing the recorded moving picture information from the DVD 1 will be schematically described below.

First of all, the recording process will be outlined below.

In the recording process, the switch 140 is changed over to the side of video information Sv entered from the outside, upon a control signal Scsw1 from the system controller 125, and the switch 141 is changed over to the side of formatter 122, upon a control signal Scsw2 from the system controller 125.

In this state, the spindle motor 132 rotates the loaded DVD 1 at a preset number of rotations in accordance with a spindle control signal Sss from the servo IC 131.

On one hand, the video information Sv (except for the MPEG still image) to be recorded in the video zone VZ of the DVD 1 is entered from the outside, and then passed as a switch signal Ssw via the switch 140 into the video encoder 123.

And the video encoder 123 performs an encoding process (specifically, a compression encoding process of the MPEG method) with an encoding rate preset for the switch signal Ssw (video information Sv) in accordance with a control signal Scv from the system controller 125, to generate an encoded video signal Sev for output to the multiplexer 134.

On the other hand, the audio information Sa as the recording information to be recorded in the video zone VZ of the DVD 1 is entered from the outside, and then passed into the audio encoder 124.

And the video encoder 124 performs an encoding process (specifically, a same compression encoding process of the MPEG method as that of the video information Sv) with an encoding rate preset for the audio information Sa in accordance with a control signal Sca from the system controller 125, to generate an encoded audio signal Sea for output to the multiplexer 134.

If there is a synchronous relation between the encoded video signal Sev and the encoded audio signal Sea, the multiplexer 134 convolutes the encoded video signal Sev and the encoded audio signal Sea at a preset timing to generate a convolution signal Smx for output to the formatter 122.

Then, the formatter 122 combines a navigation information signal Snd with the convolution signal Smx to have a physical format as shown in FIG. 1 in accordance with a control signal Scf from the system controller 125, to generate a format signal Smt that is then output via the switch 141 as a switch signal Sgz to the modulating unit 121.

Then, each piece of recording information input as the convolution signal Smx into the formatter 122 is output as a recording information signal Sfm to the system controller 125 at a preset timing to generate the navigation information in the navigation information generator 126.

And, the modulating unit 121 performs a predetermined modulation process (specifically, a so-called 8-16 modulation process) for the switch signal Sgz to generate a modulating signal Sfe for output to the pickup 120.

Thereby, the pickup 120 generates a light beam B that is intensity modulated by the modulating signal Sfe, forms a pit corresponding to the navigation information and each piece of recording information contained in the modulating signal Sfe on an information track by applying the beam onto the information track on the information recording face, not shown, of the DVD 1, and records the navigation information and each piece of recording information in the physical format as shown in FIG. 1 on the DVD 1.

Then, some deviation between the focused position of light beam B and the information track in the directions perpendicular and horizontal to the information recording face can be resolved by moving an objective lens (for focusing the light beam B), not shown, within the pickup 120 in the perpendicular and horizontal directions (i.e., performing a focus servo control and a tracking servo control), in accordance with a pickup servo signal Ssp output from the servo IC 131.

Therefore, the servo IC 131 generates a spindle control signal Sss and a pickup servo signal Ssp in accordance with a control signal Ssc from the system controller 125, and outputs them to the spindle motor 132 and the pickup 120.

Next, the reproducing process for detecting and reproducing the recorded moving picture information from the DVD 1 in accordance with the navigation information recorded concurrently will be outlined below.

In the reproducing process, first of all, the switch 136 is changed over to the side of demultiplexer 135, upon a control signal Scsw3 from the system controller 125.

In this state, the pickup 120 generates a light beam B for reproduction with constant intensity to be applied to an information track, and generates a detection signal Spp corresponding to the recording information based on a reflected light from the information track where the pit is formed, outputting it to the demodulating unit 128.

Thereby, the demodulating unit 128 performs a demodulation process for the detection signal Spp, which corresponds to the modulation process in the modulating unit 121, generating a demodulated signal Spd to be output via the switch 136 to the demultiplexer 135.

And the demultiplexer 135 demultiplexes the video information and the audio information from the demodulated signal Spd, and generates a demultiplexed signal Sdmx containing the video information and a demodulated audio signal Spda containing the audio information which are then output to the video decoder 129.

Then, the video decoder 129 performs a decoding process for the demultiplexed signal Sdmx, which corresponds to the encoding process of fixed encoding rate in the video encoder 123, in accordance with a control signal Scdv from the system controller 125, and generates a decoded video signal Sdv for output to an external monitor, not shown.

Moreover, the audio decoder 130 performs a decoding process for the demodulated audio signal Spda, which corresponds to the encoding process of fixed encoding rate in the audio encoder 124, in accordance with a control signal Scda from the system controller 125, and generates a decoded audio signal Sda for output to an external amplifier, not shown.

On one hand, the operation unit 133 generates an operation signal Sin corresponding to the operation to be output to the system controller 125, when the operator performs an operation for executing the recording process or reproducing process in the information recording/reproducing apparatus S.

Moreover, the navigation information generator 126 generates the navigation information signal Snd containing each piece of navigation information to be recorded on the DVD 1 in the recording process under the control of the system controller 125 in accordance with an operation signal Sin and a recording information signal Sfm, and outputs it to one input terminal of the formatter 122.

Thereby, the formatter 122 convolutes the recording information in the convoluted signal Smx and the navigation information in the navigation information signal Snd to generate the format signal Smt containing the recording information in the physical format as shown in FIG. 1.

In parallel to these operations, the system controller 125 sends or receives the necessary information as a memory signal Sm to or from the memory 127, and generates the control signals Scv, Sca, Scf, Ssc, Scdv, Scda, Scsw1, Scsw2 and Scsw3 for output to the corresponding components.

(B) Embodiment of Recording Process of Still Image Information

Referring to FIG. 6, a recording process for recording the MPEG still image and the corresponding JPEG image 51 on the DVD 1 and a reproducing process for reproducing the recorded MPEG still image will be described below.

In recording the MPEG still image and the JPEG image 51 according to the embodiment, the JPEG image 51 is firstly recorded in the still image zone JZ on the DVD 1, the recorded JPEG image 51 is read and converted into the MPEG still image, the converted MPEG still image is recorded in the video zone VZ on the DVD 1, and lastly the text information for associating the recorded MPEG still image with the JPEG image 51 is generated and recorded in the video zone VZ in the physical format as shown in FIGS. 1 to 4.

That is, in the recording process, the switch 141 is changed over to the side of still image information Spg in accordance with a control signal Scsw2 from the system controller 125, and the switches 140, 136 and 137 are changed over to the sides of size converter 139, switch 137, and still image decoder 138, respectively, in accordance with the control signals Scsw1, Scsw3 and Scsw4 from the system controller 125.

In this state, the JPEG image 51 to be recorded in the still image zone JZ on the DVD 1 is generated and output as the still image information Spg from a digital still camera, not shown, that generated the JPEG image 51, and the still image information Spg is output as a switch signal Sgz via the switch 141 to the modulating unit 121.

And the modulating unit 121 performs a predetermined modulation process for the switch signal Sgz to generate a modulating signal Sfe for output to the pickup 120.

Thereby, the pickup 120 generates a light beam B that is intensity modulated by the modulating signal Sfe, forms a pit corresponding to the JPEG image 51 contained in the modulating signal Sfe on an information track within the information recording face, not shown, in the still image zone JZ on the DVD 1 by applying the beam onto the information track on the information recording face, and records the JPEG image 51 in the physical format as shown in FIGS. 1 to 4 on the DVD 1 (step S1).

It is determined whether or not the recording of all the JPEG images is completed (step S2). If not (NO at step S2), the procedure returns to step S1 to continue the recording process for the JPEG image 51, while if so (YES at step S2), a processing for converting the recorded JPEG image 51 into the MPEG image and recording the MPEG image is performed (step S3).

That is, when the recording process at step S3 is performed, the switch 141 is firstly changed over to the side of formatter 122 upon a control signal Scsw2 from the controller 125.

In this state, all the recorded JPEG images 51 are read as the demodulated signals Spd via the pickup 120 and the demodulating unit 128 and output via the switches 136 and 137 to the still image decoder 138.

Then, the JPEG image 51 in the demodulated signal Spd is decoded into the original still image by the still image decoder 138 to generate a still image conversion signal Sjp for output to the size converter 139.

And the size converter 139 converts the so-called angle of view in the still image conversion signal Sjp into the angle of view in accordance with the MPEG standards to generate an angle of view conversion signal Sjpg to be output as a switch signal Ssw via the switch 140 to the video encoder 123.

Thereafter, the converted MPEG still image is recorded in the video zone VZ in accordance with the MPEG standards, using the functions of the video encoder 123, the modulating unit 121 and the pickup 120, as in the recording process for the moving picture information.

And it is determined whether or not the recording of all the MPEG still images has been completed (step S4). If not completed (NO at step S4), the procedure returns to step S3 to continue the converting and recording process for the MPEG image. On the contrary, if completed (YES at step S4), the navigation information useful in reproducing the recorded MPEG image is generated separately in the navigation information generator 126, and recorded in the physical format as shown in FIG. 1 in the video zone VZ (step S5), and the text information as exemplified in FIGS. 2 to 4 indicating the relation (correspondence) between the recorded MPEG still image and the JPEG image 51 is generated and recorded (step S6). Lastly, the file system information for managing hierarchically the recorded MPEG still image and the JPEG image 51 is generated in the system controller 125 and recorded (step S7). Thereby, the recording process for each still image according to the embodiment is completed.

The file system information contains, for each JPEG image 51 recorded in the above manner, information indicating the correspondence between its attribute (specifically, attribute composed of the number of still image group 50 to which it belongs, the number of JPEG image 51 in the still image group 50 to which it belongs) and the recording position in the still image zone JZ where the JPEG image 51 is recorded.

The recorded MPEG still image is reproduced through the same process as when reproducing the moving picture, and output to the external television apparatus.

(C) Embodiment of Reproduction and Output Process of Still Image Information

Referring to FIG. 7, a process for reproducing the MPEG still image recorded on the DVD 1 in the recording process by detecting the JPEG image 51 corresponding to the MPEG still image being reproduced, and printing it by the external printer, not shown, will be described below.

When the printing process is performed, it is premised that the printer is connected to the output terminal of the switch 137 that is not on the side of the still image decoder 138. Further, the switch 137 is changed over to the printer side, upon a control signal Scsw4 from the system control 125, and the switch 136 is changed over to the side of the switch 137 upon a control signal Scsw3 from the system controller 125.

In this state, it is determined whether or not there is an operation of printing the JPEG image 51 corresponding to the MPEG image being output at present in the operation unit 133 (step S10). If there is no operation (NO at step S10), the procedure waits till there is any operation, while if there is any operation (YES at step S10), the number of object 20 corresponding to the specified MPEG still image is detected in accordance with an operation signal Sin corresponding to the operation (step S11), the number of JPEG image 51 corresponding to the detected number of object is retrieved from the text information as exemplified in FIGS. 3 and 4 (step S12), the recording position of JPEG image 51 having its retrieved number is retrieved and acquired, employing the file system information (practically within the still image zone JZ) (step S13), and the JPEG image 51 recorded at the acquired recording position is output as a demodulated signal Spd via the pickup 120, the demodulating unit 128, the switch 136 and the switch 137 to the printer, not shown. Consequently, the JPEG image 51 contained in the demodulating signal Spd output in the printer is printed (step S14).

As described above, in the operation of the information recording/reproducing apparatus S of this embodiment, the still images of the same contents are recorded, employing both the JPEG standards and the MPEG standards, and even with any desired output method, the still images of the same contents can be output to the outside.

Since the text information for associating the MPEG still image and the JPEG image 51 in the correspondence relation is recorded on the DVD 1, the required JPEG image 51 can be detected rapidly, in the case of printing the JPEG image 51 corresponding to the MPEG still image being displayed, while the MPEG still image is being displayed on the television apparatus.

Moreover, since the hierarchical structures of the still images are associated in the text information, the MPEG still image and the JPEG image 51 corresponding to the still images of the same contents can be easily retrieved.

In the above embodiment, the JPEG image 51 corresponding to the MPEG still image being displayed is retrieved and printed. Besides, the MPEG still image corresponding to the JPEG image 51 being output outside is retrieved in a reverse order to the embodiment (FIG. 7), on the basis of the text information, and the retrieved MPEG still image can be displayed on the television apparatus.

The programs with the flowcharts of FIGS. 6 and 7 may be recorded in a recording medium such as a flexible disk or a hard disk, or distributed via a network such as the Internet, and read and executed by the microcomputer etc., which can operate as the system controller 125.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2001-347964 filed on Nov. 13, 2001 including the specification, claims, drawings and summary is incorporated herein by reference in its entirety.

1. An information recording apparatus (S) comprising:
first recording device (125) for recording an image information on a recording medium in first format;
second format recording device (125) for recording the image information on said recording medium in second format that is different from said first format; and
a related information recording device (125) for recording the related information for interrelating first format image information recorded in said first format, and the second format image information recorded in said second format onto said recording medium.

2. The information recording apparatus (S) according to claim 1, wherein said related information relates a hierarchical structure of said first format image information and a hierarchical structure of said second format image information.

3. The information recording apparatus (S) according to claim 1 or 2, wherein said image information is still image information, said first format is a format for displaying the still image corresponding to said still image information on a television apparatus, and said second format is a format for printing the still image corresponding to said still image information.

4. The information recording apparatus (S) according to claim 3, wherein said first format is a still image format conforming to the MPEG (Moving Picture Experts Group) standards, and said second format is a still image format conforming to the JPEG (Joint Photographic Coding Experts Group) standards.

5. An information reproducing apparatus (S) for reproducing a recording medium, wherein:
said recording medium comprising:
a first recording area (VZ) for recording the image information in first format;
a second recording area (JZ) for recording the image information in second format that is different from said first format; and
a related information recording area (10) for recording the related information for interrelating first format image information recorded in said firs format, and the second format image information recorded in said second format;
said information reproducing apparatus comprising:
a selection device (133) for selecting one of said first format image information and said second format image information to be output to the outside;
a detection device (120) for detecting the other of said first format image information and said second format image information associated with said selected one of image information from said recording medium, on the basis of the recorded related information; and
an output device (125) for outputting the detected other image information to the outside with an output method corresponding to the second format.

6. An information reproducing apparatus (S) for reproducing a recording medium, wherein:
said recording medium comprising:
a first recording area (VZ) for recording the image information in first format;
a second recording area (JZ) for recording the image information in second format that is different from said first format;
a related information recording area (10) for recording the related information for interrelating first format image information recorded in said first format, and the second format image information recorded in said second format; and
said image information is still image information, said first format is an output mode for displaying the still image corresponding to said still image information on a television apparatus, and said second format is an output mode for printing the still image corresponding to said still image information;
said information reproducing apparatus comprising:
a selection device (133) for selecting any one of the still images corresponding to said first format image information displayed on said television apparatus;
a detection device (120) for detecting the still images corresponding to said second format image information associated with said selected still image from said recording medium, on the basis of said recorded related information; and
an output device (125) for outputting said detected still image to the outside for printing.

7. An information recording method comprising:
a first recording process of recording the image information on a recording medium in first format;
an second format recording process of recording the image information on said recording medium where said image information is recorded in said first format, using second format that is different from said first format; and
a related information recording process of recording the related information for interrelating first format image information recorded in said first format, and the second format image information recorded in said second format onto said recording medium.

8. An information reproducing method for reproducing a recording medium, wherein:
said recording medium comprising:
a first recording area (VZ) for recording the image information in first format;
a second recording area (JZ) for recording the image information in second format that is different from said first format; and
a related information recording area (10) for recording the related information for interrelating first format image information recorded in said first format, and the second format image information recorded in said second format;
said information reproducing method comprising:
a selection process of selecting one of said first format image information and said second format image information to be output to the outside;
a detection process of detecting the other of said first format image information and said second format image information associated with said selected one of image information from said recording medium, on the basis of the recorded related information; and
an output process of outputting the detected other image information to the outside with an output method corresponding to the second format.

9. An information reproducing method for reproducing a recording medium, wherein:
said recording medium comprising:
a first recording area (VZ) for recording the image information in first format;
a second recording area (JZ) for recording the image information in second format that is different from said first format;
a related information recording area (10) for recording the related information for interrelating first format image information recorded in said first format, and the second format image information recorded in said second format; and
said image information is still image information, said first format is an output mode for displaying the still image corresponding to said still image information on a television apparatus, and said second format is an output mode for printing the still image corresponding to said still image information;
said information reproducing method comprising:
a selection process of selecting any one of the still images corresponding to said first format image information displayed on said television apparatus;
a detection process of detecting the still images corresponding to said second format image information associated with said selected still image from said recording medium, on the basis of said recorded related information; and
an output process of outputting said detected still image information to the outside for printing.

10. A recording control program that is executed on a recording computer built in an information recording apparatus for recording the image information on a recording medium, comprising:
first format recording step for recording the image information on the recording medium in first format;
second format recording step for recording the image information on said recording medium where said image information is recorded in said first format, using second format that is different from said first format; and
related information recording step for recording the related information for interrelating first format image information recorded in said first format, and the second format image information recorded in said second format onto said recording medium.

11. A reproduction control program that is executed on a reproducing computer built in an information reproducing apparatus for reproducing a recording medium, wherein:
said recording medium comprising:
a first recording area (VZ) for recording the image information in first format;
a second recording area (JZ) for recording the image information in second format that is different from said first format; and
a related information recording area (10) for recording the related information for interrelating first format image information recorded in said first format, and the second format image information recorded in said second format;
said reproduction control program comprising:
a selection step for selecting one of said first format image information and said second format image information to be output to the outside;
a detection step for detecting the other of said first format image information and said second format image information associated with said selected one of image information from said recording medium, on the basis of the recorded related information; and
an output step for outputting the detected other image information to the outside with an output method corresponding to the second format.

12. A reproduction control program that is executed on a reproducing computer built in an information reproducing apparatus for reproducing a recording medium, wherein:
said recording medium comprising:
a first recording area (VZ) for recording the image information in first format;
a second recording area (JZ) for recording the image information in second format that is different from said first format;
a related information recording area (10) for recording the related information for interrelating first format image information recorded in said first format, and the second format image information recorded in said second format; and
said image information is still image information, said first format is an output mode for displaying the still image corresponding to said still image information on a television apparatus, and said second format is an output mode for printing the still image corresponding to said still image information;
said reproduction control program comprising:
a selection step for selecting any one of the still images corresponding to said first format image information displayed on said television apparatus;
a detection step for detecting the still images corresponding to said second format image information associated with said selected still image from said recording medium, on the basis of said recorded related information; and
an output step for outputting said detected still image to the outside for printing.

13. An information recording medium, wherein the recording control program according to claim 11 is recorded to be readable on said recording computer.

14. An information recording medium, wherein the reproduction control program according to claim 12 is recorded to be readable on said reproducing computer.

15. A recording medium comprising:
a first recording area (VZ) for recording the image information in first format;
a second recording area (JZ) for recording the image information in second format that is different from said first format; and
a related information recording area (10) for recording the related information for interrelating first format image information recorded on said recording medium in said first format, and the second format image information recorded on said recording medium in said second format.

16. The recording medium according to claim 15, wherein said related information relates a hierarchical structure of said first format image information and a hierarchical structure of said second format image information.

17. The recording medium according to claim 15 or 16, wherein said image information is still image information, said first format is a format for displaying the still image corresponding to said still image information on a television apparatus, and said second format is a format for printing the still image corresponding to said still image information.

18. The recording medium according to claim 17, wherein said first format is a still image format conforming to the MPEG (Moving Picture Experts Group) standards, and said second format is a still image format conforming to the JPEG (Joint Photographic Coding Experts Group) standards.
